(19) United States
(12) Patent Application Publication
(10) Pub. No.: US 2014/0241367 A1
(43) Pub. Date: Aug. 28, 2014

(54) COMMUNICATION SYSTEM, CONTROLLER, COMMUNICATION METHOD, AND PROGRAM

(71) Applicant: NEC CORPORATION, Minato-ku, Tokyo (JP)

(72) Inventor: Kiyohisa Ichino, Tokyo (JP)

(73) Assignee: NEC CORPORATION, Tokyo (JP)

(21) Appl. No.: 14/348,728

(22) PCT Filed: Oct. 30, 2012
(86) PCT No.: PCT/JP2012/006952

§ 371 Date: Mar. 31, 2014

(30) Foreign Application Priority Data
Dec. 27, 2011 (JP) 2011-286152

(51) Int. Cl. H04L 12/721; H04L 12/751

(52) U.S. Cl. CPC H04L 45/38; H04L 45/02
USPC 370/392

(57) ABSTRACT

In a centrally controlled communication system where a packet loss may occur in a switch on a forwarding path, transmission of a packet of a high-priority protocol is enabled. The communication system includes a group of switches which process a received packet(s) by referring to a flow entry that defines processing content to be applied to the packet(s) and a controller that controls the group of switches. The controller comprises a topology detection unit that detects a network topology composed of a link(s) satisfying predetermined transmission quality from among links connecting respective ones of the switches, based on information obtained from the group of switches. When communication using a predetermined communication protocol that requires the predetermined communication quality occurs between arbitrary nodes, the controller creates a flow entry to be applied to a packet(s) of the predetermined communication protocol, and then set the created flow entry in each switch on a path set between the arbitrary nodes.

### TECHNICAL FIELD

### Cross-Reference to Related Applications

The present invention is based upon and claims the benefit of the priority of Japanese Patent Application No. 2011-286152 (filed on Dec. 27, 2011), the disclosure of which is incorporated herein in its entirety by reference. The present invention relates to a communication system, a controller, a communication method, and a program. More specifically, the invention relates to a communication system including a controller that performs centralized control of switches, the controller, a communication method, and a program.

### BACKGROUND ART

Since a computer network such as Ethernet (registered trademark) is a distribution type where a switch (or a router) operates autonomously, it is difficult to correctly and quickly grasp an event occurring in the network, and it takes time to identify a location of occurrence of a fault and recover from the fault. This is regarded as a problem. Further, each switch should include capability sufficient to operate autonomously. Consequently, the function of the switch is complicated.

On the other hand, a centrally controlled network includes a controller for managing switches and the like, and reduces the above-mentioned problem with respect to the network of the autonomous distribution type. OpenFlow (OpenFlow; refer to Non Patent Literature 1) is one of technologies for implementing the centrally controlled network. The OpenFlow may improve communication efficiency by global optimization of communication paths and may realize visualization of the network. The OpenFlow may relatively reduce the function demanded for the switch, and may reduce the cost of the switch, thereby allowing reduction of cost of facilities in the entire network.

FIG. 15 is a block diagram showing a configuration of a network (hereinafter referred to as a communication system X101) based on the OpenFlow. The communication system X101 mainly includes a controller X10, switches 11-1 and 11-2, nodes 12-1 and 12-2, links 13, and channels 14.

The controller X10 performs recognition of a network topology, control over the switches 11-1 and 11-2 subordinate to the controller X10, monitoring of a fault in each of the switches 11-1 and 11-2 and the links 13, and determination of a communication path.

Each of the switches 11-1 and 11-2 forwards a packet received from an adjacent one of the nodes 12 (12-1 or 12-2) or another one of the switches to an appropriate destination. Further, each of the switches 11-1 and 11-2 updates an internal state thereof or transmits the packet to an outside, according to an instruction from the controller X10. Details of the switches 11-1 and 11-2 will be described later.

Each node 12 (12-1/12-2) is a communication end point of a terminal or a server. The link 13 connects the interfaces of the switches 11-1 and 11-2, the switch 11-1 and the node 12, or the switch 11-2 and the node 12 to deliver packets between the interfaces.

Each channel 14 transmits a control message between the controller X10 and a corresponding one of the switches 11-1 and 11-2.

FIG. 16 is a block diagram showing a structure of each switch (hereinafter denoted as a “switch 11” when no particular distinction is made between the switches 11-1 and 11-2). The switch 11 mainly includes ports 40-1 to 40-N, 48-1 to 48-N, a management port 41, a controller interface 42, a flow entry storage unit 43, a packet multiplexing unit 44, a flow entry search unit 45, an action application unit 46, and an internal switch 47.

Each of the ports 40-1 to 40-N, 48-1 to 48-N (in which N is an integer not less than one. When no particular distinction is made among the ports 40-1 to 40-N, 48-1 to 48-N, the ports 40-1 to 40-N, 48-1 to 48-N are denoted as “ports 40”.) transmits to or receives from an adjacent one of the nodes 12 (12-1 or 12-2) or another one of the switches 11 the packet through the link 13.

The management port 41 transmits to or receives from the controller X10 the control message through the channel 14.

The controller interface 42 adds or modifies a flow entry stored in the flow entry storage unit 23 according to the control message received from the controller X10 through the management port 41. When the control message received from the controller X10 includes a packet transmission instruction (corresponding to a “Packet-Out” message in Non Patent Literature 1), the controller interface 42 transmits a packet included in the control message to the internal switch 47. The controller interface 42 encapsulates a packet and a reception port number received from the action application unit 46 into the control message, and transmits the encapsulated control message (corresponding to a “Packet-In” message in Non Patent Literature 1) to the controller X10 through the management port 41. The reception port number included in the control message is the number of a port 40 that received the packet.

The flow entry storage unit 43 stores flow entries, using a table (hereinafter referred to as a “flow table”) that stores the flow entries. The flow entry describes how the switch 11 will process a packet received through the port 40.

FIG. 17 is a block diagram showing a structure of the flow table held in the flow entry storage unit 43. M (M being an integer not less than one) flow entries 60-1 to 60-M (hereinafter denoted as “flow entries 60” when no particular distinction is made among the flow entries 60-1 to 60-M) are stored in a flow table 43X in FIG. 17. Each flow entry 60 includes two fields of a matching condition 61 and an action 62. The action 62 indicates processing content to be applied to a packet that satisfies the matching condition 61. For example, when the action 62 says “forwarding the packet to a specified one of the ports 40”, the packet matching the matching condition 61 is forward to the specified port.

The packet multiplexing unit 44 multiplexes packets received through the ports 40 on a per-packet basis to transmit the multiplexed packet to both of the flow entry search unit 45 and the action application unit 46.

The flow entry search unit 45 determines whether or not the flow entry matching the received packet is present in the flow table. When the flow entry 60 having the matching condition 61 matching the received packet is present in the flow table, the flow entry search unit 45 transmits the action 62 of the flow entry 60 to the action application unit 46. On the other hand, when the flow entry 60 having the matching condition matching the received packet is not present, the flow entry search unit 45 transmits the action 62 of default to the flow action application unit 46. The examples of the action 62 of default are “forwarding the packet to the controller X10” and “discarding the packet”. It is assumed herein that the action 62 of default is set to “forwarding the packet to the controller X10”.

The action application unit 46 applies the action 62 received from the flow entry search unit 45 to the packet received from the packet multiplexing unit 44. When the action 62 indicates transmission of the packet through the port 40, the action application unit 46 outputs the packet to the internal switch 47. When the action 62 indicates forwarding of the packet to the controller X10, the action application unit 46 sends the packet and a reception port number 50 of the packet to the controller interface 42.

The internal switch 47 forwards the packet received from the controller interface 42 or the action application unit 46 to the specified port 40.

The above description is directed to the configuration and the basic operation of the OpenFlow switch described in Non Patent Literature 1. As other patent literatures, Patent Literatures 1 and 2 may be pointed out. Patent Literature 1 discloses a path control apparatus (corresponding to the above-mentioned controller) that sets an appropriate effective period for a packet forwarding rule (corresponding to the flow entry described above) held in the above-mentioned switch to reduce the controller's load and eliminate unnecessary flow entries.

Patent Literature 2 discloses a management method in a network to be controlled centrally by a network manager. Paragraphs 0031 to 0032 of Patent Literature 2 describes that each switch in the network operates in a similar manner to the above-mentioned OpenFlow switch. The last sentence in the paragraph 0031 describes that a packet matching a lot of flow header entries is assigned to a flow entry having a highest priority, or that a rule like longest match is used.

### CITATION LIST

### Patent Literature

[PTL 1]
JP Patent Kokai Publication No. JP2011-101245A
[PTL 2]
JP Patent Kohyou Publication No. JP2010-541426A

### Non Patent Literature

[NPL 1]
“OpenFlow—Enabling Innovation in Your Network”, [online], [searched on November 14, Heisei 23 (2011)], Internet <URL: http://www.openflow.org/>

### SUMMARY OF INVENTION

### Technical Problem

The entire disclosure of the above cited Patent and Non Patent Literatures are incorporated herein by reference thereto. The following analysis is given by the present invention. There are communication protocols in which packets must be transmitted without loss. One of such communication protocols is an FCoE (Fibre Channel over Ethernet). The FCoE is a standard for encapsulating a fiber channel frame into an Ethernet packet, for transmission. The FCoE does not permit a situation where a packet (FCoE Ethernet packet) disappears due to congestion. The FCoE assumes use of Ethernet flow control mechanisms defined in the IEEE 802.3x standard and the IEEE 802.1Qbb standard in order to avoid the packet loss due to the congestion.

In the following explanation, the communication protocol such as the FCoE that requires a network to be of high quality and needs to be processed more preferentially than the other communication protocols is described as a high-priority protocol.

Let us consider a case where a packet of the high-priority protocol is transmitted from the one node 12-1 to the other node 12-2 on the OpenFlow network (communication system X101 in FIG. 15). In order for the controller X10 to dynamically determine the communication path or visualize a usage status of the network with respect to the high-priority protocol, the controller X10 must know occurrence of communication using the high-priority protocol. The controller X10 also needs to find the communication path which satisfies the quality required by the high-priority protocol.

In the standard for the OpenFlow in Non Patent Literature 1, however, it is defined that when the switch 11 forwards a packet to the controller X10 through the channel 14, the packet may be discarded. The controller X10 may set in the switch 11 a flow entry that causes a packet to be discarded, re-routed or the like, according to a traffic status collected by the controller X10 or an instruction of a network manager.

As described above, in the OpenFlow in Non Patent Literature 1, a packet of the high-priority protocol may be lost before or after detection of the packet. Consequently, the OpenFlow network in Non Patent Literature 1 cannot satisfy communication quality required by the high-priority protocol such as the FCoE, unless any modification is made to the OpenFlow standard. Though the modification of the OpenFlow standard is considered, it incurs a harmful effect that the existing OpenFlow switches cannot be used.

Such a situation is not limited to the OpenFlow. A similar situation also applies to a centrally controlled communication system where a packet loss may occur in a switch on a forwarding path. Thus there is much desired in the art.

It is an object of the invention to contribute to provision of a method of transmitting a packet of a high-priority protocol in a centrally controlled communication system in which a packet loss may occur in a switch on a forwarding path.

### Solution to Problem

According to a first aspect, there is a provided a communication system, the system comprising a group of switches which process a received packet(s) by referring to a flow entry that defines processing content to be applied to the packet(s), and a controller that controls the switches by setting the flow entry in one of the group of switches.

The controller comprises a topology detection unit that detects a network topology composed of a link(s) satisfying predetermined transmission quality from among links connecting respective ones of the group of switches, based on information obtained from the group of switches.

When communication using a predetermined communication protocol that requires the predetermined communication quality occurs between arbitrary nodes associated with the network topology, the controller creates a flow entry to be applied to a packet(s) of the predetermined communication protocol and then sets the created flow entry in each switch on a path set between the arbitrary nodes.

According to a second aspect, there is provided a controller, wherein the controller is connected to a group of switches which process a received packet(s) by referring to a flow entry that defines processing content to be applied to the packet(s);

The controller comprises a topology detection unit that detects a network topology composed of a link(s) satisfying predetermined transmission quality from among links connecting respective ones of the group of switches, based on information obtained from the group of switches.
When communication using a predetermined communication protocol that requires the predetermined communication quality occurs between arbitrary nodes associated with the network topology, the controller creates a flow entry to be applied to a packet(s) of the predetermined communication protocol and then sets the created flow entry in each switch on a path set between the arbitrary nodes.

According to a third aspect, there is provided a communication method using a controller connected to a group of switches which process a received packet(s) by referring to a flow entry that defines processing content to be applied to the each packet(s). The method comprises the steps of the controller:

detecting a network topology composed of a link(s) satisfying predetermined transmission quality from among links connecting respective ones of the group of switches, based on information obtained from the group of switches; and
creating a flow entry to be applied to a packet(s) of the predetermined communication protocol and then setting the created flow entry in each switch on a path set between arbitrary nodes associated with the network topology when communication using a predetermined communication protocol that requires the predetermined communication quality occurs between the arbitrary nodes. This method is linked with a specific machine, which is the controller that controls the group of switches in a centrally controlled network.

According to a fourth aspect, there is provided a program for a computer comprising a controller connected to a group of switches which process a received packet(s) by referring to a flow entry that defines processing content to be applied to the packet(s). The program causes the computer to execute processes of:

detecting a network topology composed of a link(s) satisfying predetermined transmission quality from among links connecting respective ones of the group of switches, based on information obtained from the group of switches; and
creating a flow entry to be applied to a packet(s) of the predetermined communication protocol and then setting the created flow entry in each switch on a path set between arbitrary nodes associated with the network topology when communication using a predetermined communication protocol that requires the predetermined communication quality occurs between the arbitrary nodes. This program may be recorded in a computer readable recording medium which may be non-transitory. That is, the present invention may also be embodied as a computer program product.

### Advantageous Effects of Invention

According to the present disclosure, a packet may be transmitted with communication quality required by a high-priority protocol in a centrally controlled communication system where a packet loss may occur in a switch on a forwarding path.

### BRIEF DESCRIPTION OF DRAWINGS

FIG. 1 is a diagram showing a configuration of a communication system according to one exemplary embodiment of the present disclosure.

FIG. 2 is a diagram showing a configuration of a communication system according to a first exemplary embodiment of the present disclosure.

FIG. 3 is a block diagram showing a configuration of a controller according to the first exemplary embodiment of the present disclosure.

FIG. 4 is a diagram showing a configuration of a node position table in the first exemplary embodiment of the present disclosure.

FIG. 5 is a diagram showing a configuration of a link information table in the first exemplary embodiment of the present disclosure.

FIG. 6 is a sequence diagram showing an operation (initialization process) of the first exemplary embodiment of the present disclosure.

FIG. 7 is a flowchart showing an operation (path setting process) of the first exemplary embodiment of the present disclosure.

FIG. 8 is a diagram showing an example of the link information table in a network configuration in FIG. 2.

FIG. 9 is a diagram showing a specific example of the node position table in the network configuration in FIG. 2.

FIG. 10 is a diagram showing a specific example of a flow table of a switch (before occurrence of communication using a high-priority protocol) in the first exemplary embodiment of the present disclosure.

FIG. 11 is a diagram showing a specific example of a flow table of a switch (before the occurrence of the communication using the high-priority protocol) in the first exemplary embodiment of the present disclosure.

FIG. 12 is a diagram showing a specific example of the flow table of the switch (after the occurrence of the communication using the high-priority protocol) in the first exemplary embodiment of the present disclosure.

FIG. 13 is a diagram showing a specific example of the flow table of the switch (after the occurrence of the communication using the high-priority protocol) in the first exemplary embodiment of the present disclosure.

FIG. 14 is a diagram showing a specific example of a configuration of the controller (information processing apparatus) in the first exemplary embodiment of the present disclosure.

FIG. 15 is a diagram showing a configuration of a communication system described as a background art.

FIG. 16 is a block diagram showing a configuration of a switch described as the background art.

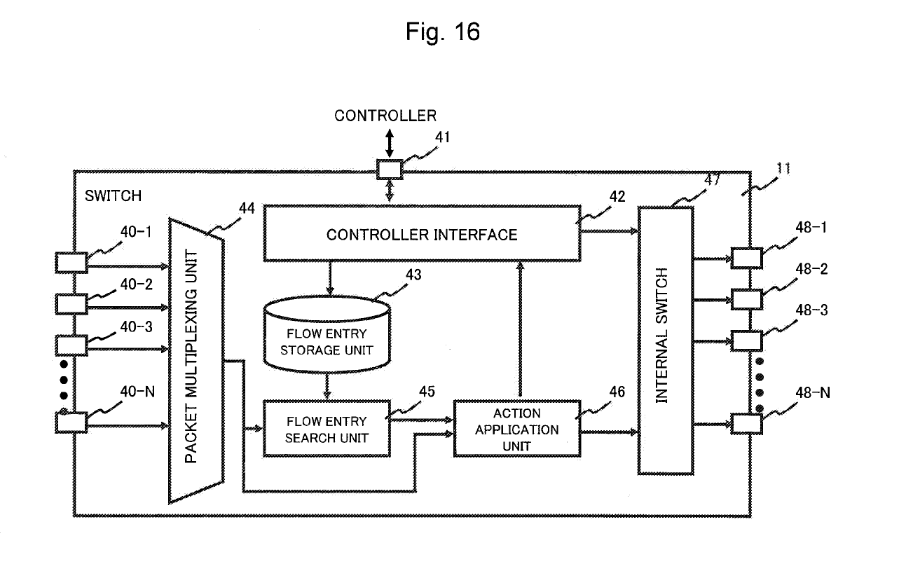

FIG. 17 is a diagram showing a configuration of a flow table of the switch described as the background art.

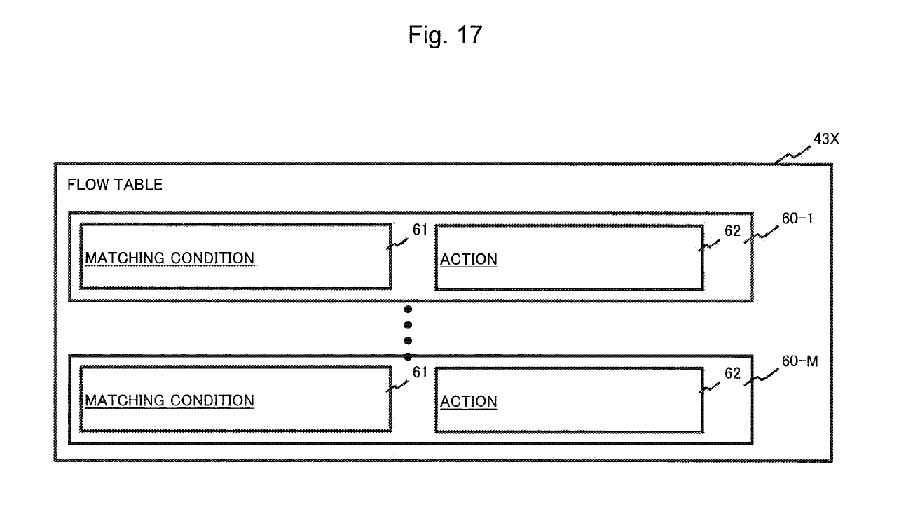

### DESCRIPTION OF EMBODIMENTS

First, a summary of one exemplary embodiment of the present disclosure will be described with reference to a drawing. A reference symbol in the drawing appended to this summary is appended to each element for the sake of convenience, as an example for helping understanding of the disclosure, and does not intend to limit the present disclosure to the mode illustrated in the drawing.

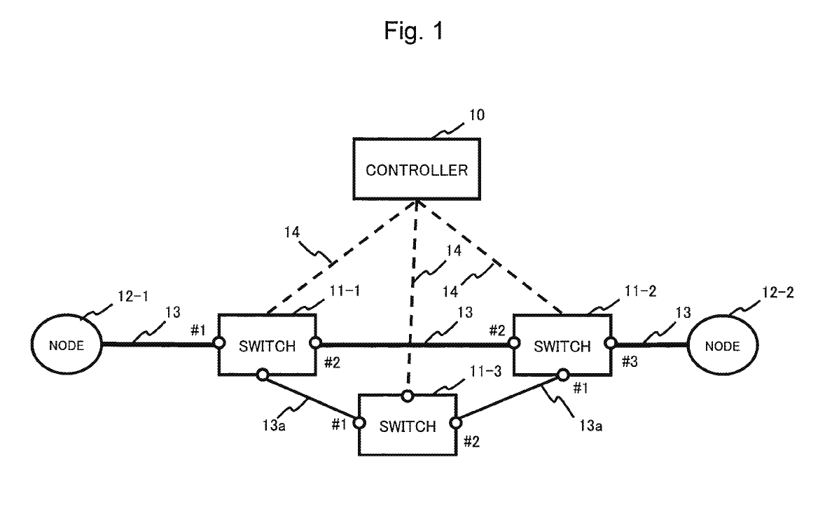

As shown in FIG. 1, the exemplary embodiment of the present disclosure may be implemented by a configuration including a group of switches (indicated by reference symbols 11-1, 11-2, and 11-3 in FIG. 1) each of which processes a received packet(s) by referring to a flow entry that describes processing content to be applied to each packet and a controller (indicated by reference symbol 10 in FIG. 1) that controls the group of switches by setting the flow entry in the switches (each switch, for example).

The controller includes a topology detection unit that detects a network topology composed of a link(s) (indicated by reference symbol 13 in FIG. 1) satisfying predetermined transmission quality from among links (indicated by reference symbols 13 and 13a in FIG. 1) connecting respective ones of the group of switches, based on information obtained from the group of switches. When communication using a predetermined communication protocol that requires predetermined transmission quality occurs between arbitrary nodes associated with a network topology, the controller creates a flow entry to be applied to a packet of the predetermined communication protocol, and then sets the created flow entry in the switches (each switch) on a path set between the arbitrary nodes.

In the example in FIG. 1, the topology detection unit detects the network topology composed of the node 12-1, the switch 11-1, the switch 11-2, and the node 12-2. That is, the switch 11-3 is not connected to the switch 11-1 or 11-2 via the link 13 satisfying the predetermined transmission quality. Based on the type of a port obtained from port information and the number of physical links between the switches, it may be determined whether or not a certain one of the links satisfies the predetermined transmission quality by using an LLDP or the like that will be described later.

With the above-mentioned configuration, a packet of a high-priority protocol is processed not through the switch 11-3. The packet may be therefore transmitted with communication quality required by the high-priority protocol.

### First Exemplary Embodiment

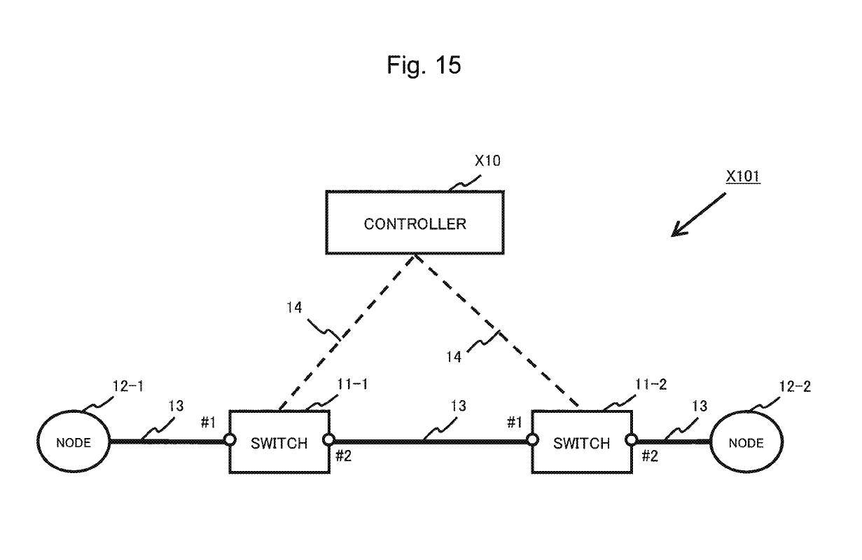

When a load on a controller X10 increases in a network configuration as shown in FIG. 15, it is effective to reduce the number of packets forwarded to the controller X10 in order to avoid malfunction of a communication system X101 due to an excessive load state of the controller X10. As a method of reducing the number of packets forwarded to the controller X10, there may be pointed out a method of causing a switch 11 to discard a packet to be forwarded to the controller X10 (setting a flow entry indicating discard of the packet, if necessary) autonomously by the controller X10 or based on an instruction of a network manager.

Thus, in the OpenFlow disclosed in Non Patent Literature 1, when the switches 11 (11-1, 11-2) in FIG. 15 forward a packet to the controller X10 through a channel 14, the packet may be lost. A first exemplary embodiment of the present disclosure in view of such a packet loss between the switches 11 (11-1, 11-2) and the controller will be described in detail with reference to drawings. In the drawings for explaining the exemplary embodiment to be described below, in principle, same reference symbols are assigned to same components, and repeated explanation of the same components will be omitted.

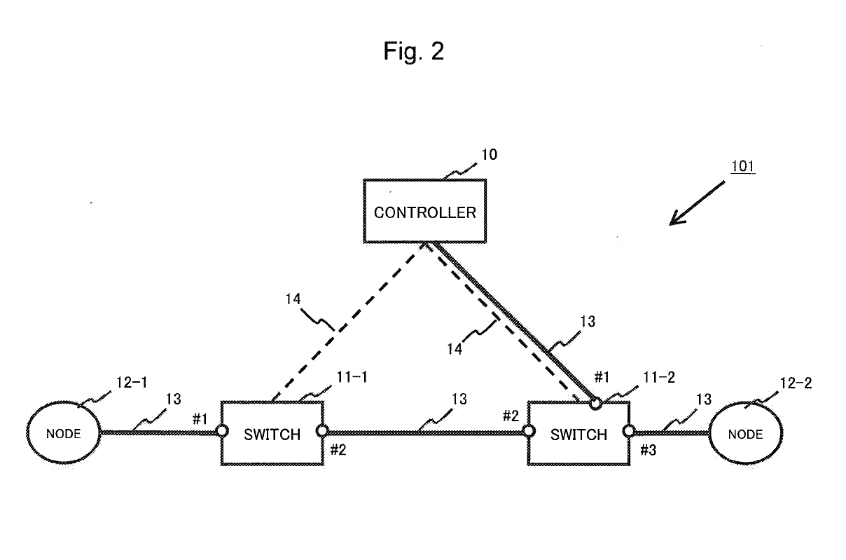

FIG. 2 is a diagram showing a configuration of an OpenFlow network in this exemplary embodiment (hereinafter described as a “communication system 101”). FIG. 2 shows the communication system 101 including a controller 10 and switches 11-1 and 11-2 each connected to the controller 10 through a channel 14 or a link 13, for implementing communication between nodes 12-1 and 12-2. The switches 11-1 and 11-2 and the node 12-1 and the node 12-2 (hereinafter simply denoted as “nodes 12” when no particular distinction between the nodes 12-1 and 12-2 is made) are linked via the links 13. The numbers of the controller, the switches, and the nodes shown in FIG. 2 are simplified for understanding of the present disclosure, and are not limited to those illustrated. A number “#1” written in the vicinity of an end point of the link 13 or the like in FIG. 2 indicates a port number of the switch.

The controller 10 performs recognition of a network topology, control over the switches 11-1 and 11-2 (hereinafter simply denoted as “switches 11” when no particular distinction is made) subordinate to the controller 10, monitoring of a fault in each of the links 13 and the switches 11, determination of a communication path, and processing of a high-priority protocol.

The switches 11, the nodes 12, the links 13, and channels 14 are the same as those in the communication system X101 described in the background art. The difference between the communication system 101 and X101 is that the communication system 101 has at least one switch (switch 11-2 in FIG. 2) connected to the controller 10 through the link 13. It is assumed that each link 13 satisfies transmission quality required by the high-priority protocol. When the high-priority protocol is an FCoE, for example, Ethernet flow control is enabled on the link 13.

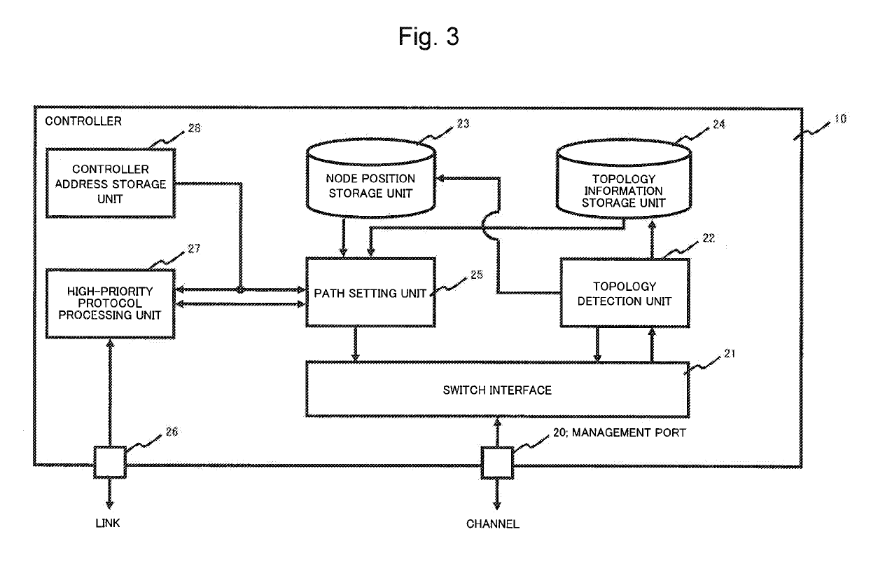

FIG. 3 is a block diagram showing a configuration of the controller 10. FIG. 3 shows the configuration of the controller 10 including a management port 20, a switch interface 21, a topology detection unit 22, a node position storage unit 23, a topology information storage unit 24, a path setting unit 25, a port 26, a high-priority protocol processing unit 27, and a controller address storage unit 28.

The management port 20 transmits or receives a control message to or from each of the switches 11 through the channel 14.

The switch interface 21 performs management of the channels 14 such as addition, deletion, alive monitoring, or the like. When the switch interface 21 receives the control message including a packet from the switch 11 through the management port 20, the switch interface 21 forwards the control message to the topology detection unit 22. Further, the switch interface 21 transmits the control message received from the topology detection unit 22 or the path setting unit 25 to the switch 11 through the management port 20.

The topology detection unit 22 interprets the packet included in the control message received from the switch interface 21, and updates the node position storage unit 23 and the topology information storage unit 24. The topology detection unit 22 generates the control message including an instruction of transmitting a neighbor discovery packet (that will be described later) to detect the network topology, and then outputs the control message to the switch interface 21.

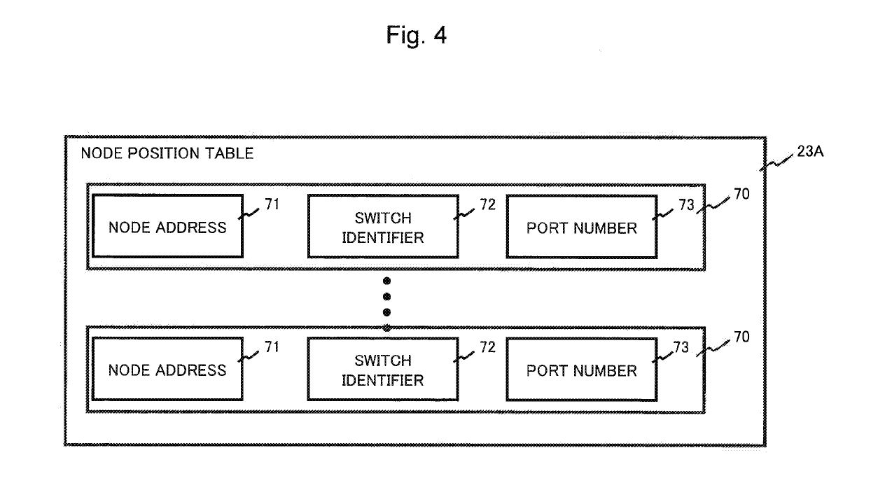

The node position storage unit 23 stores information on the switches 11 and ports of the switches 11 connected to the controller 10 and the nodes 12, as positional information on the nodes 12 or the controller 10. FIG. 4 is a diagram showing a node position table 23A held in the node position storage unit 23. FIG. 4 shows the node position table capable of storing a plurality of entries 70 associated with each node 12 (or the controller 10). Each entry 70 includes three fields of a node address 71 (or address of the controller), a switch identifier 72, and a port number 73. The node address 71 indicates the network address of the node 12 (or the controller 10). The switch identifier 72 indicates an identifier for the switch 11 adjacent to the node 12 (or the controller 10). The port number 73 is the number of the port of the switch 11 connected to the node 12 (or the controller 10).

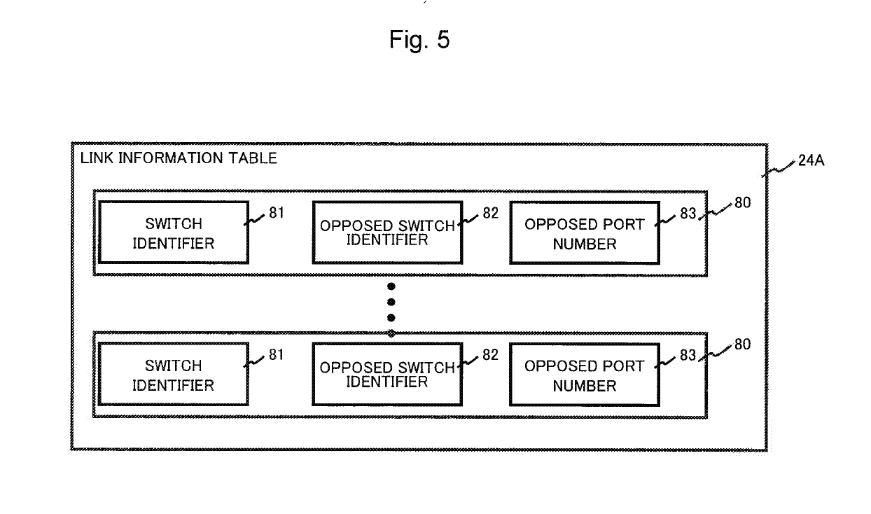

The topology information storage unit 24 stores connection relationships between the respective switches 11 through the links 13. FIG. 5 is a diagram showing an example of a link information table 24A held in the topology information storage unit 24. FIG. 5 shows the link information table capable of storing a plurality of entries 80 each associated with the link 13 in one-way direction connecting the switches. Each entry 80 includes three fields of a switch identifier 81, a peer switch identifier 82, and a peer port number 83. The switch identifier 81 is an identifier for the switch 11 at a transmission end of the link 13. The peer switch identifier 82 and the peer port number 83 respectively indicate an identifier for the switch 11 at a reception end of the link 13 and the port number of the switch 11 at the reception end of the link 13.

When the network address of a transmission source and the network address of a transmission destination are given from the high-priority protocol processing unit 27, the path setting unit 25 refers to the node position storage unit 23 and the topology storage unit 24 to calculate a communication path from the transmission source to the transmission destination. The path setting unit 25 refers to the node position storage unit 23, the topology information storage unit 24, and the controller address storage unit 28 after detection of the network topology of the communication system 101 to calculate respective communication paths from all the nodes 12 to the controller 10. The path setting unit 25 creates a flow entry 60 indicating forward of a packet of the high-priority protocol along each of these calculated paths for each switch 11 on the path. Further, the path setting unit 25 outputs the control message for setting the flow entry in each switch 11 on the path through the switch interface 21. These flow entries are added to the flow tables in flow entry storage units 43 of the respective switches 11 on the path.

The port 26 transmits or receives a packet to or from an adjacent one of the switches 11.

The high-priority protocol processing unit 27 implements a management process defined by the high-priority protocol while transmitting or receiving the packet through the port 26. When the high-priority protocol is the FCoE, for example, the high-priority protocol processing unit 27 performs a log-in process and name resolution of the node 12, notification of a status change to the node 12, and the like. When the high-priority protocol processing unit 27 transmits a packet to the node 12, the high-priority protocol processing unit 27 requests the path setting unit 25 to set a communication path from the controller 10 to the node 12 of the target. The network address of the controller 10 that serves as a transmission source is read from the controller address storage unit 28. When the high-priority protocol processing unit 27 opens direct communication between the nodes 12, the high-priority protocol processing unit 27 requests the path setting unit 25 to set a communication path between the nodes 12.

The controller address storage unit 28 stores the network address of the controller 10.

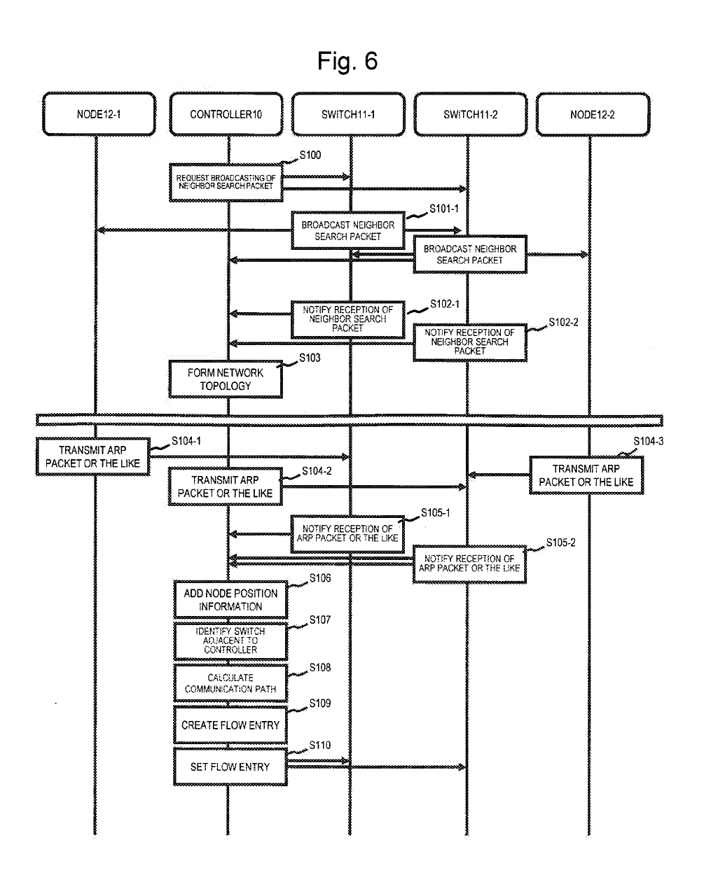

Next, operation of this exemplary embodiment will be described in detail with reference to drawings. First, an initialization process will be described. FIG. 6 is a sequence diagram showing a flow of the initialization process to be carried out when the communication system 101 is activated in this exemplary embodiment. A first purpose of initialization is to detect the network topology of the communication system 101. A second purpose of initialization is to set a necessary flow entry in the flow table of each switch 11 so that a packet of the high-priority protocol transmitted from the node 12 reaches the high-priority protocol processing unit 27 of the controller 10.

It is assumed that, in an initial state, the node position storage unit 23 and the topology information storage unit 24 of the controller 10 are empty. It is also assumed that the flow table of each switch 11 is empty.

The topology detection unit 22 of the controller 10 generates the control message that requests broadcasting of the neighbor discovery packet, and transmits the control message to each switch 11 (in step S100 in FIG. 6). The topology detection unit 22 generates the control message indicating broadcast of the neighbor discovery packet including an identifier for the switch 11 of each transmission source. One example of such a neighbor discovery packet is an LLDP packet defined in an LLDP (Link Layer Discovery Protocol) which is one of neighbor discovery protocols.

When receiving from the controller 10 the control message generated in step S100, each switch 11 transmits the neighbor discovery packet included in that control message from all ports 40 (in steps S101-1 and S101-2).

Each switch 11 determines whether or not a flow entry having a matching condition matching the packet is present in the flow table when receiving the neighbor discovery packet from another switch 11 adjacent to each switch 11. Since the flow table at this point is empty, the flow entry matching the neighbor discovery packet is not present. Thus, an action of default is applied to this neighbor discovery packet, the neighbor discovery packet and the reception port number are encapsulated into the control message, and then the control message is forwarded to the controller 10, as described in the background art (in steps S102-1 and S102-2). A reception port number 50 indicates the number of a port that has received the neighbor discovery packet. For example, the switch 11-2 that has received the neighbor discovery packet from the switch 11-1 transmits to the controller 10 the control message including the neighbor discovery packet and the number of the port (#2; refer to FIG. 2) that has received the neighbor discovery packet.

When receiving the control message including the neighbor discovery packet and the reception port number 50 from each switch 11 through the switch interface 21, the topology detection unit 22 interprets the control message, and then adds a new entry 80 to the link information table of the topology information storage unit 24 (in step S103). The switch identifier 81 of the entry 80 to be added is the identifier for the switch 11 of the transmission source included in the neighbor discovery packet in the control message. The peer switch identifier 82 of the entry 80 to be added is the identifier for the switch 11 that has issued the control message. The peer port number 83 of the entry 80 to be added is the reception port number 50 included in the control message.

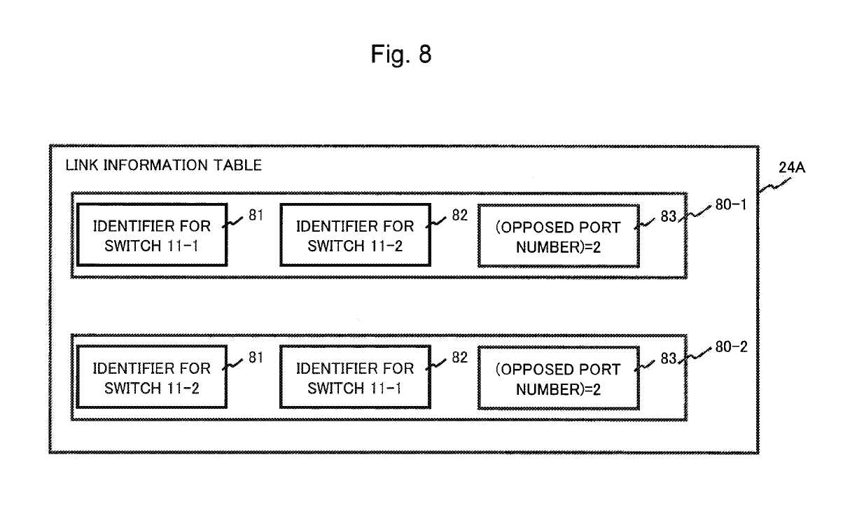

FIG. 8 shows an example of the link information table in the communication system 101 shown in FIG. 2 at a point of time when step S103 has been completed. Referring to FIG. 2, there are two switches 11-1 and 11-2 in the communication system 101, and those switches 11-1 and 11-2 are connected by one link 13. An entry 80-1 in FIG. 8 means the link 13 in one-way direction from the switch 11-1 to the switch 11-2, while an entry 80-2 means the link 13 in one-way direction from the switch 11-2 to the switch 11-1.

Then, each of the nodes 12 and the high-priority protocol processing unit 27 of the controller 10 transmits a packet including the network address of the transmission source to the link 13 at a predetermined timing (in steps S104-1 to S104-3). Preferably, this packet is transmitted before main communication is started. One example of such a packet is an ARP (Address Resolution Protocol) packet for knowing a link layer address (MAC address) associated with an IP (Internet Protocol) address or the LLDP packet. The network address of the transmission source included in the packet to be transmitted by each node 12 is the network address of the node 12. The network address of the transmission source included in the packet to be transmitted by the high-priority protocol processing unit 27 is the network address of the controller 10 stored in the controller address storage unit 28.

Each switch 11 determines whether or not a flow entry having a matching condition matching the packet is present in the flow table when receiving the packet from the node 12 or the controller 10 adjacent to each switch 11 through the link(s) 13. Since the flow table is empty at this point, the flow entry having the matching condition matching that packet is not present. Thus, the action of default is applied in this case as well. That packet and the reception port number 50 are encapsulated into the control message, and then the control message is forwarded to the controller 10 (in step S105).

When receiving the control message forwarded to the controller 10 from each switch 11 through the switch interface 21 in step S105, the topology detection unit 22 interprets the control message to add a new entry 70 to the node position storage unit 23 (in step S106). The node address 71 of the entry 70 to be added is the network address of the transmission source included in the packet in the control message. The switch identifier 72 of the entry 70 to be added is the identifier for the switch 11 that has issued the control message. The port number 73 of the entry 70 to be added is the reception port number 50 included in the control message.

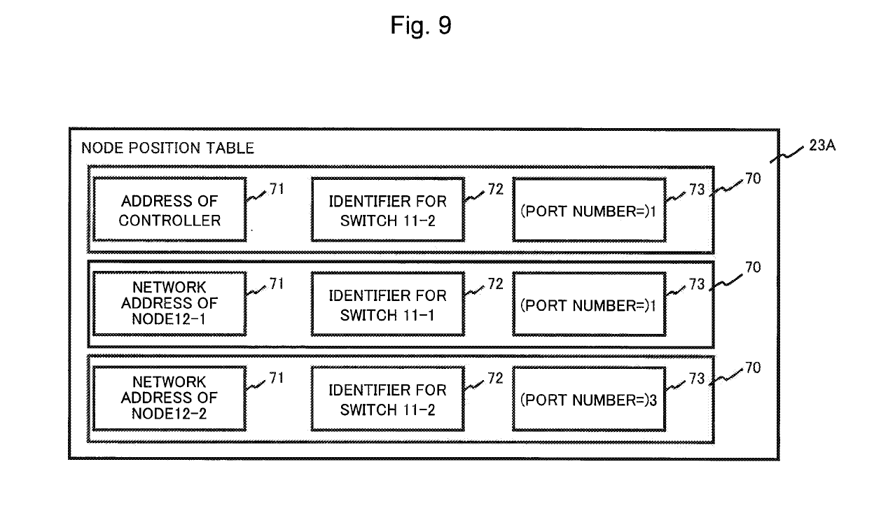

FIG. 9 shows an example of the node position table in the communication system 101 shown in FIG. 2 at a point when step S106 has been completed. An uppermost entry on the page of FIG. 9 is associated with the high-priority protocol processing unit 27, and a second uppermost entry and a third uppermost entry on the page of FIG. 9 are respectively associated with the nodes 12-1 and 12-2. When the node 12-1 is taken as an example, the node 12-1 in the communication system 101 in FIG. 2 is connected to a port #1 of the switch 11-1. Accordingly, the switch identifier 72 of the entry 70 associated with the node 12-1 is the identifier for the switch 11-1, and the port number 73 is the port #1 of the switch 11-1. This allows the controller 10 to know the position of the node 12-1. Similarly, the controller 10 can know that the node 12-2 is connected to a port #3 of the switch 11-2.

Next, the path setting unit 25 of the controller 10 identifies the switch 11 adjacent to the controller 10 through the link 13, by referring to the node position storage unit 23 and the controller address storage unit 28 (in step S107). Specifically, the path setting unit 25 searches the node position storage unit 23 (refer to FIG. 9) to obtain the switch identifier 72 of the entry 70 having the node address 71 equal to the network address of the controller. The network address of the controller 10 is set in the uppermost entry in FIG. 9. The switch identifier 72 in this uppermost entry 70 is the identifier for the switch 11-2. Therefore, the controller 10 can find that the switch 11-2 is adjacent to the controller 10.

The path setting unit 25 refers to the topology information storage unit 24 to calculate a communication path from each switch 11 to the switch 11 adjacent to the controller 10 through the link 13 (in step S108). The calculated path does not include the channel 14.

In the communication system 101 shown in FIG. 2, content of the topology information storage unit 24 is as shown in FIG. 8. The result of step S107 shows that the switch 11 adjacent to the controller 10 is the switch 11-2. Referring to FIG. 9, it can be seen that there is only one path from the switch 11-1 to the switch 11-2 (from the uppermost entry in FIG. 8). When there are a plurality of candidate paths, an optimal path may also be selected using a known shortest path search algorithm such as Dijkstra's algorithm.

The path setting unit 25 creates a flow entry for forwarding a packet of the high-priority protocol to the controller 10 from each switch 11 along the path calculated in step S108, for each switch on the path (in step S109).

The path setting unit 25 outputs the control message for adding the flow entry created in step S109 to the flow table of each switch 11 on the path through the switch interface 21 (in step S110).

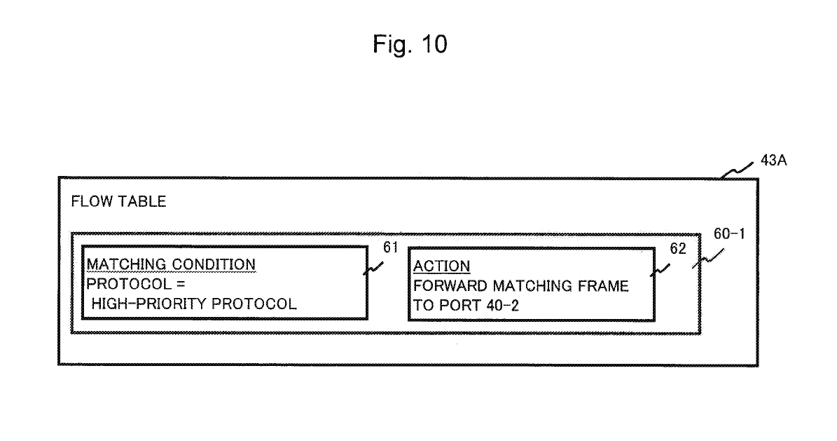

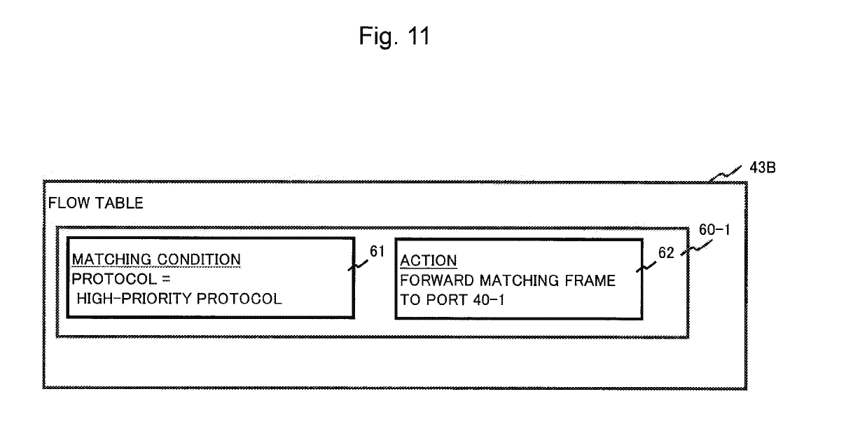

FIGS. 10 and 11 show specific examples of flow entries set in flow tables 43A/43B of the switch 11-1 and the switch 11-2 after execution of step S110 in the communication system 101 shown in FIG. 2. A flow entry 60-1 in the flow table 43A of the switch 11-1 in FIG. 10 indicates a rule for forwarding a packet of the high-priority protocol that has flowed into the switch 11-1 to the switch 11-2 through a port 40-2 (#2). A flow entry 60-1 in a flow table 43B of the switch 11-2 in FIG. 11 indicates a rule for forwarding the packet of the high-priority protocol that has flowed into the switch 11-2 to the high-priority protocol processing unit 27 of the controller 10 through a port 40-1 (#1).

With the above arrangement, when a packet of the high-priority protocol is received at the switch 11-1 or the switch 11-2, the flow entry 60-1 or 60-2 is applied to the packet which results in being forwarded. This ensures that the controller 10 is able to detect inflow of the packet of the high-priority protocol.

Next, a path setting process to be performed after the initialization process will be described. The high-priority protocol processing unit 27 of the controller 10 may transmit a packet to the node 12 during execution of the management process defined by the high-priority protocol. For example, a case may be pointed out where the high-priority protocol processing unit 27 returns a response packet to the node 12 in response to a packet received from the node 12. The high-priority protocol processing unit 27 may permit communication between the node 12-1 and the node 12-2.

At the point of time when the initialization process described before has been completed, only the flow entry 60 indicating forward of a packet of the high-priority protocol from the node 12 to the controller 10 is set in the flow table 43 of each switch 11. The high-priority protocol processing unit 27 requests the path setting unit 25 to register in each switch 11 the flow entry 60 indicating forward of the packet of the high-priority protocol from the controller 10 to the node 12, if needed. The high-priority protocol processing unit 27 also requests the path setting unit 25 to register in each switch 11 the flow entry 60 indicating forward of the packet of the high-priority protocol from the node 12-1 (or 12-2) to another node 12-2 (or 12-1), if needed.

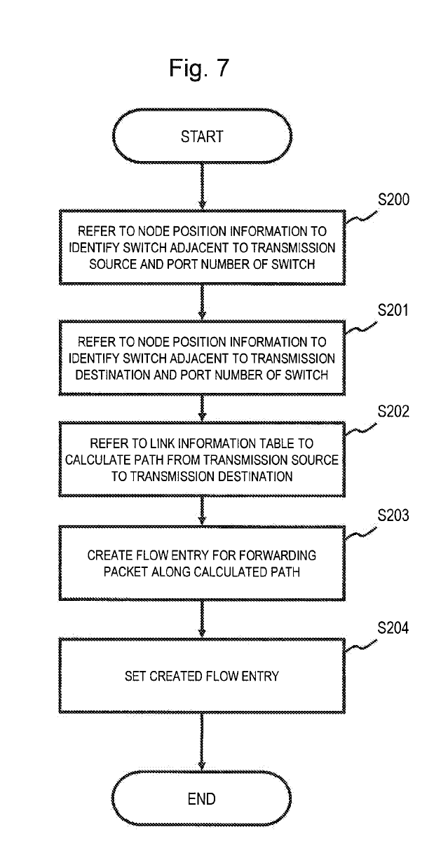

FIG. 7 is a flowchart showing a flow of the process in which the path setting unit 25 calculates a communication path from a transmission source to a transmission destination and sets a flow entry in each switch 11 according to a request from the high-priority protocol processing unit 27.

Referring to FIG. 7, the path setting unit 25 of the controller 10 first refers to the node position storage unit 23 to obtain the switch identifier 72 and the port number 73 of the switch 11 adjacent to the transmission source (in step S200). Specifically, the path setting unit 25 searches the node position table 23A (refer to FIG. 4) of the node position storage unit 23 for an entry having the node address 71 equal to the network address of the transmission source to obtain the switch identifier 72 and the port number 73.

As a result of the initialization process described before, the node position table 23A of the node position storage unit 23 in the communication system 101 shown in FIG. 2 is as illustrated in FIG. 9. When the transmission source is the node 12-1 in FIG. 2, for example, the second uppermost entry in the node position table 23A is an entry indicating the position of the transmission source. In this case, the identifier for the switch 11-1 and “1” are obtained from the entry in FIG. 9. These mean that the node 12-1 connects with the port #1 of the switch 11-1 in FIG. 2.

Next, the path setting unit 25 refers to the node position storage unit 23 to obtain the switch identifier 72 and the port number 73 of the switch 11 adjacent to the transmission destination (in step S201). Specifically, the path setting unit 25 searches the node position table 23A (refer to FIG. 4) of the node position storage unit 23 for an entry having the node address 71 equal to the network address of the transmission destination to obtain the switch identifier 72 and the port number 73.

When the transmission destination is the node 12-2 in FIG. 2, for example, the third uppermost entry in the node position table 23A is an entry indicating the position of the transmission destination. In this case, the identifier for the switch 11-2 and “3” are obtained from the entry in FIG. 9. These mean that the node 12-2 connects with the port #3 of the switch 11-2 in FIG. 2.

Next, the path setting unit 25 refers to the topology information storage unit 24 to calculate the communication path from the switch 11 adjacent to the transmission source to the switch adjacent to the transmission destination (in step S202). This communication path does not include the channel 14.

As a result of the initialization process described before, the link information table 24A of the topology information storage unit 24 is as shown in FIG. 8, in the communication system 101 shown in FIG. 2. It is assumed that the transmission source and the transmission destination are respectively the node 12-1 and the node 12-2 in the communication system 101 in FIG. 2, for example. The switch adjacent to the transmission source and the switch adjacent to the transmission destination are respectively identified as the switch 11-1 and the switch 11-2, as the results of step S200 and step S201. Referring to the link information table 24A in FIG. 8, it can be seen that there is only one path from the switch 11-1 to the switch 11-2 (from the uppermost entry 80). When there are a plurality of candidate paths, an optimal path may also be selected using the known shortest path search algorithm such as the Dijkstra's algorithm.

Next, the path setting unit 25 creates the flow entry indicating forward of a packet of the high-priority protocol along the path calculated in step S202, for each switch 11 on the path (in step S203).

Finally, the path setting unit 25 outputs to the switch interface 21 the control message for adding the flow entry generated in step S203 to the flow table 43A of each switch 11 on the path (in step S204).

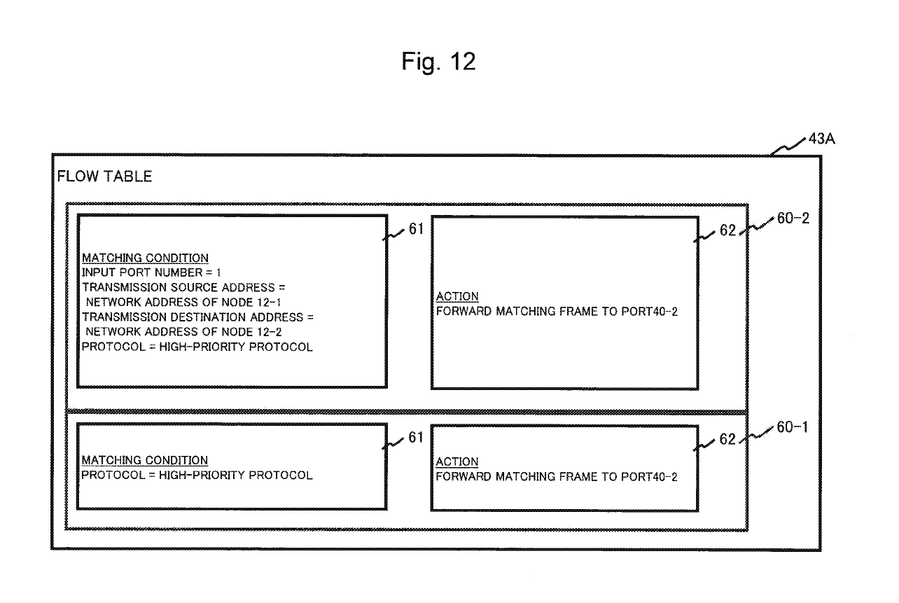

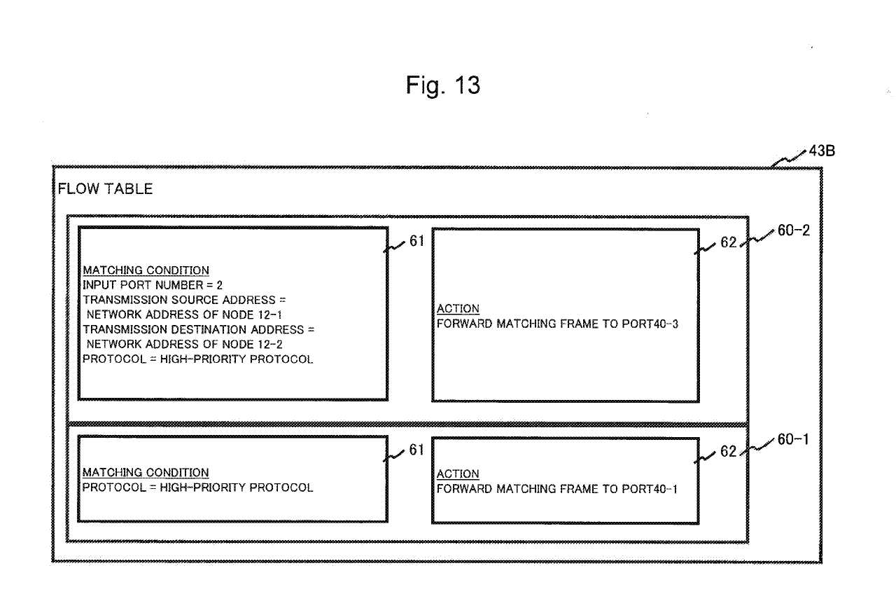

FIG. 12 shows an example of the flow table 43A set in the switch 11-1 when packet communication between the node 12-1 and the node 12-2 in FIG. 2 is permitted. FIG. 13 shows an example of the flow table 43B set in the switch 11-2 when the packet communication between the node 12-1 and the node 12-2 in FIG. 2 is permitted.

The flow entries added in step S204 are an uppermost flow entry 60-2 on the page of FIG. 12 and an uppermost flow entry 60-2 on the page of FIG. 13. The uppermost flow entry 60-2 in FIG. 12 represents a rule for forwarding a packet of the high-priority protocol flowed into the switch 11-1 from the node 12-1 to the switch 11-2 through the port 40-2 (#2). The uppermost flow entry 60-2 in FIG. 13 represents a rule for forwarding a packet of the high-priority protocol flowed into the switch 11-2 from the switch 11-1 to the node 12-2 through a port 40-3 (#3).

Preferably, the priority of the flow entry (flow entry for communication using the high-priority protocol) to be added in step S204 is set to be higher than the priority of the flow entry (flow entry for detection of a packet of the high-priority protocol) to be added in step S110 of the initialization process in FIG. 6. This arrangement will be given using the above-mentioned examples in FIGS. 12 and 13. When a received packet is the one of the high-priority protocol, both of the flow entries 60-1 and 60-2 will hit as a result of search of the flow table 43A. In this case, it's desirable that the flow entry 60-2 is finally chosen. One priority control method is that the entry in the more upper position in each of the flow tables 43A and 43B is treated as the one having the higher priority order than the other entry, as shown in FIGS. 12 and 13. Alternatively, priority information may be set in an arbitrary field of each flow entry, and comparison between these priority information may be made.

As described above, according to this exemplary embodiment, a new packet of the high-priority protocol is forwarded to the controller 10 from the switch 11 through the link 13 not through the channel 14. As described in the background art, the switch 11 may discard a packet that should be originally forwarded to the controller 10 through the channel 14 when the controller's load is high. However such a packet loss cannot occur in this exemplary embodiment because a packet of the high-priority protocol is forwarded to the controller 10 through the link 13. Consequently, the communication system 101 in this exemplary embodiment may satisfy high communication quality required by the high-priority protocol.

When carrying out this exemplary embodiment, an OpenFlow protocol in Non Patent Literature 1 does not need to be modified at all. The reason for that is that the controller 10 sets the flow table of each switch 11 according to the OpenFlow protocol to ensure that a packet of the high-priority protocol is transmitted between the controller 10 and the switch or between the switches 11, through the link 13.

The above description was given about each exemplary embodiment of the present disclosure. The present disclosure is not, however, limited to the above-mentioned exemplary embodiments. The present disclosure may be further varied, replaced, and adjusted without departing from the basic technical concept of the present disclosure. In the description of the above-mentioned exemplary embodiment, it was described that at least one switch 11 (switch 11-2) and the controller 10 were connected through the link 13 and the channel 14. The link 13 and the channel 14 do not necessarily need to be separate lines. That is, the link 13 and the channel 14 may be physically multiplexed into one signal line. In this case, a known method such as wavelength multiplexing, time-division multiplexing, or frame multiplexing may also be used.

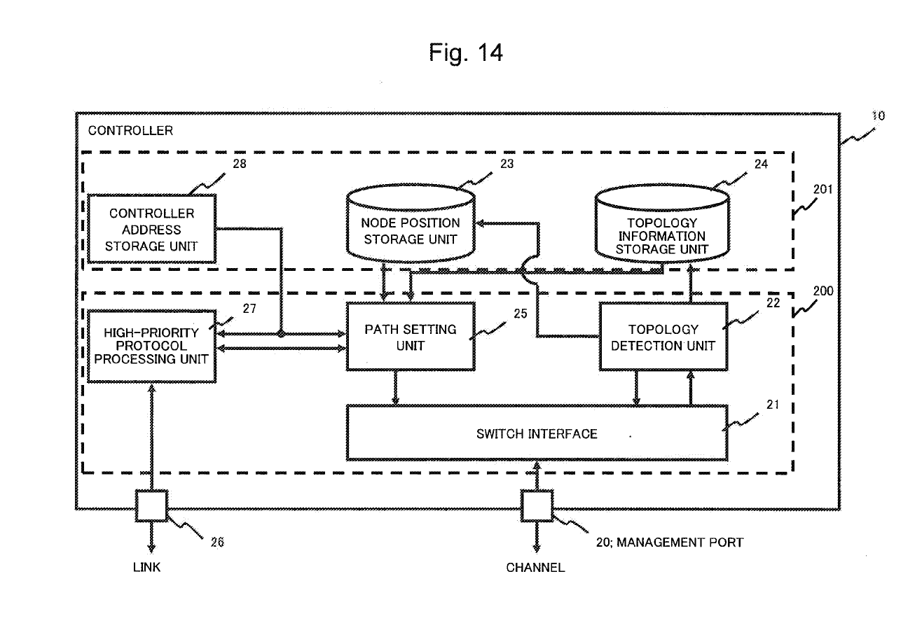

The controller 10 in this exemplary embodiment may be implemented by using an information processing apparatus such as a PC (Personal Computer). FIG. 14 is a block diagram when the controller 10 is configured using the information processing apparatus such as the PC.

A storage device 201 in FIG. 14 may be configured using a RAM (Random Access Memory), an HDD (Hard Disk Drive), or an SDD (Solid State Drive). The node position storage unit 23, the topology information storage unit 24, and the controller address storage unit 28 are disposed in the storage device 201.

A data processing device 200 is configured by including a CPU (Central Processing Unit). The data processing device 200 functions as each unit of the above-mentioned switch interface 21, topology detection unit 22, path setting unit 25, and high-priority protocol processing unit 27 by executing processing corresponding to those of the switch interface 21, the topology detection unit 22, the path setting unit 25, and the high-priority protocol processing unit 27.

Each processing of the CPU may be described as a switch control program. It may also be so configured that the data processing unit 200 reads this switch control program from the storage device 201 to execute this switch control program. The data processing device 200 may also be configured to read the switch control program from a computer readable recording medium of which illustration is omitted to execute the switch control program.

The switch interface 21, the topology detection unit 22, the path setting unit 25, and the high-priority protocol processing unit 27 may also be partly configured by hardware.

In the above-mentioned exemplary embodiment, it was described that the controller 10 found the network topology and managed node position, based on the neighbor discovery packet and the ARP packet. When these information is known in advance, the initialization process can also be omitted. In this case, the known information is stored in the node position storage unit 34 and the topology information storage unit 24 as initial setting, and a necessary flow entry is initially set in each switch 11.

In the above-mentioned exemplary embodiment, it was described that the controller 10 included the high-priority protocol processing unit to perform the log-in process, the name resolution, and the notification of a status change to the node 12. These processes may be performed by a server or the like other than the controller 10. In this case, the controller forms the network topology (in step S103), identifies positions of the server and the node, calculates a communication path between both of the server and the node, and sets a necessary flow entry, in the initialization process in FIG. 6.

Finally, the following summarizes the preferred modes of the present disclosure.

### <First Mode>

(See the communication system in the first aspect described above)

### <Second Mode>

In the communication system, the controller may be connected to at least one of the switches that are present on the network topology by the link satisfying the predetermined transmission quality; and the controller may detect occurrence of a communication using the predetermined communication protocol through the at least one of the switches connected by the link(s).

### <Third Mode>

In the communication system, when receiving the packet of the predetermined communication protocol, the controller may set in each switch on the network topology a flow entry notifying the controller of the occurrence of the communication using the predetermined communication protocol through the link(s) satisfying the predetermined transmission quality.

### <Fourth Mode>

In the communication system, the controller may further comprise a high-priority protocol processing unit that sets the flow entry necessary for the communication between the nodes using the predetermined communication protocol and performs a management process defined by the predetermined communication protocol.

### <Fifth Mode>

In the communication system, the topology detection unit may transmit to each of the group of switches a neighbor discovery packet that requests transmission of information on each switch and detects the network topology composed of the link(s) satisfying the predetermined transmission quality based on a response from each switch.

### <Sixth Mode>

In the communication system, the topology detection unit may perform position management of the nodes based on a packet to be transmitted before communication between the nodes or between the controller and the node(s) is started.

### <Seventh Mode>

In the communication system, the controller may set the flow entry to be applied to the packet of the predetermined communication protocol so that the flow entry is applied in accordance with a priority order higher than flow entries to be applied to the other packets.

### <Eighth Mode>

In the communication system, the controller may control the switches to forward a packet(s) other than the packet(s) of the predetermined communication protocol, using a link(s) other than the link(s) satisfying the predetermined transmission quality, in addition to the link(s) satisfying the predetermined transmission quality.

### <Ninth Mode>

(See the controller in the second aspect described above)

### <Tenth Mode>

(See the communication method in the third aspect described above)

### <Eleventh Mode>

(See the program in the fourth aspect described above)

Like the first mode, the above-mentioned ninth to eleventh modes may be developed into the second to eighth modes.

Modifications and adjustments of the exemplary embodiments and examples are possible within the scope of the overall disclosure (including claims) of the present disclosure, and based on the basic technical concept of the disclosure. Various combinations and selections of various disclosed elements (including each element of each claim, each element of each example, each element of each drawing, and the like) are possible within the scope of the claims of the present disclosure. That is, the present disclosure of course includes various variations and modifications that could be made by those skilled in the art according to the overall disclosure including the claims and the technical concept.

### REFERENCE SIGNS LIST

10, X10 controller
11, 11-1˜11-3 switch
12, 12-1, 12-2 node
13, 13a link
14 channel
20 management port
21 switch interface
22 topology detection unit
23 node position storage unit
23A node position table
24 topology information storage unit
24A link information table
25 path setting unit
26 port
27 high-priority protocol processing unit
28 controller address storage unit
40, 40-1˜40-N, 48-1˜48-N port
41 management port
42 controller interface
43 flow entry storage unit
43A, 43B, 43X flow table
44 packet multiplexing unit
45 flow entry search unit
46 flow action application unit
47 internal switch
50 reception port number
60-1˜60-M flow entry
61 matching condition
62 action
70 entry
71 node address
72 switch identifier
73 port number
80 entry
81 switch identifier
82 peer switch identifier
83 peer port number
101, X101 communication system
200 data processing device
201 storage device

1. A communication system,
said system comprising:
a group of switches which processes a received packet(s) by referring to a flow entry that defines processing content to be applied to the packet(s) and a controller that controls the switches by setting the flow entry in one of the group of switches; wherein
the controller comprises a topology detection unit that detects a network topology composed of a link(s) satisfying predetermined transmission quality from among links connecting respective ones of the group of switches, based on information obtained from the group of switches; and
when communication using a predetermined communication protocol that requires the predetermined communication quality occurs between arbitrary nodes associated with the network topology, the controller creates a flow entry to be applied to a packet of the predetermined communication protocol and then sets the created flow entry in each switch on a path set between the arbitrary nodes.

2. The communication system according to claim 1, wherein
the controller is connected to at least one of the switches that are present on the network topology by the link satisfying the predetermined transmission quality; and
the controller detects occurrence of a communication using the predetermined communication protocol through the at least one of the switches connected by the link(s).

3. The communication system according to claim 2, wherein
when receiving the packet of the predetermined communication protocol, the controller sets in each switch on the network topology a flow entry notifying the controller of the occurrence of the communication using the predetermined communication protocol through the link(s) satisfying the predetermined transmission quality.

4. The communication system according to claim 1, wherein
the controller further comprises a high-priority protocol processing unit that sets the flow entry necessary for the communication between the nodes using the predetermined communication protocol and performs a management process defined by the predetermined communication protocol.

5. The communication system according to claim 1, wherein
the topology detection unit transmits to each of the group of switches a neighbor discovery packet that requests transmission of information on each switch and detects the network topology composed of the link(s) satisfying the predetermined transmission quality based on a response from each switch.

6. The communication system according to claim 1, wherein
the topology detection unit performs position management of the nodes based on a packet to be transmitted before communication between the nodes or between the controller and the node(s) is started.

7. The communication system according to claim 1, wherein
the controller sets the flow entry to be applied to the packet of the predetermined communication protocol so that the flow entry is applied in accordance with a priority order higher than flow entries to be applied to the other packets.

8. The communication system according to claim 1, wherein
the controller controls the switches to forward a packet(s) other than the packet(s) of the predetermined communication protocol using a link(s) other than the link(s) satisfying the predetermined transmission quality, in addition to the link(s) satisfying the predetermined transmission quality.

9. A controller, wherein
the controller is connected to a group of switches which process a received packet by referring to a flow entry that defines processing content to be applied to the packet(s);
the controller comprises a topology detection unit that detects a network topology composed of a link(s) satisfying predetermined transmission quality from among links connecting respective ones of the group of switches, based on information obtained from the group of switches; and
when communication using a predetermined communication protocol that requires the predetermined communication quality occurs between arbitrary nodes associated with the network topology, the controller creates a flow entry to be applied to a packet(s) of the predetermined communication protocol and then sets the created flow entry in each switch on a path set between the arbitrary nodes.

10. A communication method using a controller connected to a group of switches which process a received packet(s) by referring to a flow entry that defines processing content to be applied to a packet(s), the method including the steps of said controller:
detecting a network topology composed of a link(s) satisfying predetermined
transmission quality from among links connecting respective ones of the group of switches, based on information obtained from the group of switches; and
creating a flow entry to be applied to a packet(s) of the predetermined communication protocol and then setting the created flow entry in each switch on a path set between arbitrary nodes associated with the network topology when communication using a predetermined communication protocol that requires the predetermined communication quality occurs between the arbitrary nodes.

11. (canceled)
